(19) United States
(12) Patent Application Publication
(10) Pub. No.: US 2006/0249920 A1
(43) Pub. Date: Nov. 9, 2006

(54) Golf bag with removable wheels

(76) Inventor: Christopher Howard Lambert, Roseville, MN (US)

Correspondence Address: Christopher H. Lambert, 2690 Oxford Street North #254, Roseville, MN, 55113, US

(21) Appl. No.: 11/121,958

(22) Filed: May 5, 2005

(51) Int. Cl. B62B 1/00

(52) U.S. Cl. 280/47.26

(57) ABSTRACT

The invention relates a golf bag that has a set of wheels that are attached to the bag and are removable. The wheels can be mounted on an axle to a base and attached to the base of the bag by the application of a semi-permanent fastening system. The wheels are employed using an attached, hinged, retractable handle. When the rolling feature of the bag is in use the base is attached to the base of the bag and the handle extended for pulling or pushing the bag on the wheels. When not in use the wheeled base can be removed and the handle retracted. Because of the detachable wheels and retractable handle the golf bag can be carried, rolled or driven on a motorized cart without additional equipment. In order to achieve this flexibility of use the rolling mechanism must become a part of the bag.

### A BRIEF SUMMARY OF THE INVENTION

This invention relates to golf bags where wheels are added to a golf bag to make it easier to use. The wheels are detachable so that the bag can fit in standard golf carts and other devices.

### BACKGROUND

The invention relates a golf bag that has a wheel or set of wheels that are attached to the bag and removable. The wheels can be mounted on an axle to a base and attached to the base of the bag by the application of a hook and loop fastening system. The wheels can be employed by the use of an attached hinged handle. When the bag is in use the wheeled base is attached to the base of the bag and the handle extended for pulling or pushing. When not in use the wheeled base can be removed and the handle retracted by flexing the hinge. This method of detaching the wheels and retracting the handle allows the bag to be carried, rolled or driven on a motorized golf cart without additional equipment. Golfers, all of whom use golf bags, have the problem of having to bring and use a separate piece of equipment in order to roll their golf bag around a golf course. Additional equipment like a pull cart takes up space and requires additional cost. The detachable wheel design allows the bag to be carried or rolled without additional equipment or cost and allows the golfer to switch from one use to another during a round of golf. In order to achieve this flexibility of use the rolling mechanism must become a part of the bag.

### OBJECTS AND ADVANTAGES

Accordingly I claim the following as my objects and advantages of the invention: to provide a golf bag with wheels that are capable of being detached thus improving on stationary golf bags and pull carts.

In addition I claim the following as objects and advantages of the invention:

to provide a golf bag that is capable of being pulled on its own wheels on a golf course, to provide a golf bag that can be carried and driven on a motorized cart in addition to being rolled on its own wheels, to provide a retractable handle that is capable of being employed in the use of the detachable wheels.

### DRAWING FIGURES

FIG. 1 shows a perspective of a golf bag according to the invention.

FIG. 2 shows a diagram of the detachable wheels.

### DRAWING REFERENCE NUMERALS

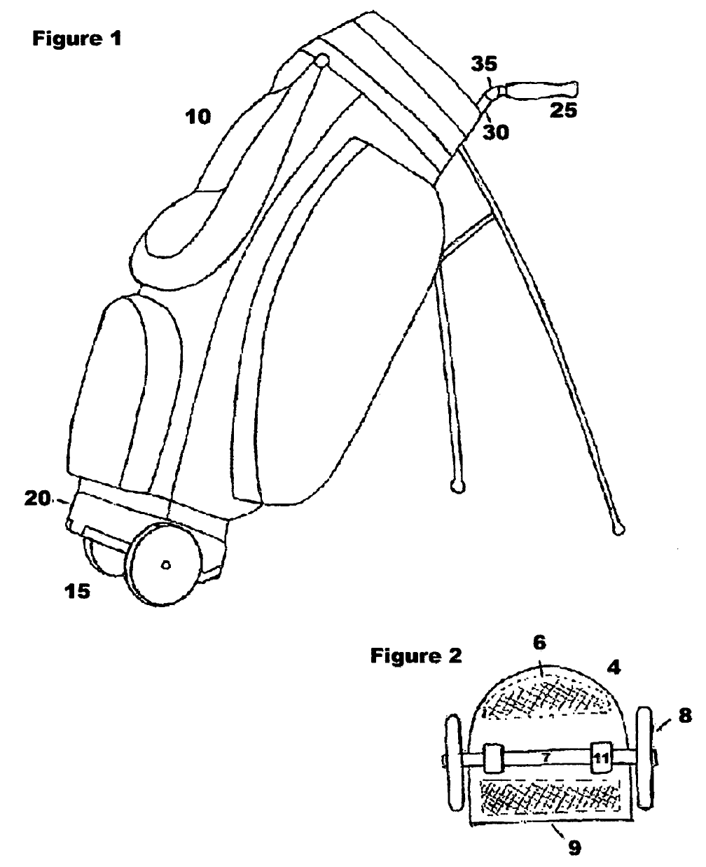

FIG. 1
10 golf bag
15 detachable wheel base
20 golf bag base
25 retractable handle
30 handle shaft
35 handle hinge
FIG. 2
4 detachable wheel base
6 attachment mechanism
7 axle
8 wheels
9 molded base
11 bearing

### DETAILED DESCRIPTION OF THE PREFERRED EMBODIMENTS

FIG. 1 shows a golf bag according to the preferred embodiment of the invention. The golf bag consists of a golf bag 10 with a molded wheeled base 15 which is attached to the base of the golf bag 20. The retractable handle 25 is fastened to the golf bag at the shaft 30. The handle 25 retracts and extends as necessary at the hinge 35.

FIG. 2 shows the detachable wheel base 4 where the wheels 8 are attached to the molded base 9 by use of an axle 7 and bearings 11. It is attached to the base of the bag 20 in FIG. 1 by use of the hook and loop fastening system 6 on the opposite side of the wheel base 9 as the wheel and axle combination.

The golf bag in FIG. 1 achieves the flexibility of use by attaching the wheeled base 4 in FIG. 2 to the base of the bag 20 in FIG. 1. When the wheeled base is attached to the bag 10 and the retractable handle extended, the bag can be pulled or pushed on its wheels. This allows the bag to be rolled without a second piece on equipment.

What is claimed is:

1. A golf bag with detachable wheels comprising:
detachable wheels, the wheeled base including:
a molded base, and attached wheels employing a fastening system on the top side of the molded base to be attached to the base of the golf bag;
a retractable handle consisting of an attached shaft, hinge and handle grip that is retractable when not in employ.

2. The golf bag of claim 1 wherein said wheeled base comprises an attachable rolling mechanism.

3. The golf bag of claim 1 wherein said handle is retractable by use of a flexible hinge.

4. The golf bag of claim 1 wherein said wheeled base can be of any number of wheels which can be attached by use of any semi-permanent fastening system.
